(19) United States
(12) Patent Application Publication
(10) Pub. No.: US 2019/0288833 A1
(43) Pub. Date: Sep. 19, 2019

(54) System and Method for Securing Private Keys Behind a Biometric Authentication Gateway

(71) Applicant: Walmart Apollo, LLC, Bentonville, AR (US)

(72) Inventors: David Martin Nelms, Rogers, AR (US); Sid Shake, Rogers, AR (US); Charles Lobo, Cave Springs, AR (US)

(21) Appl. No.: 16/354,385

(22) Filed: Mar. 15, 2019

Related U.S. Application Data
(60) Provisional application No. 62/643,841, filed on Mar. 16, 2018.

(51) Int. Cl. H04L 9/08; H04L 9/32

(52) U.S. Cl. CPC H04L 9/085; H04L 9/3231; H04L 9/0894; H04L 9/3236; H04L 2209/38; H04L 9/0866

(57) ABSTRACT

A system and a method for the system for securing private cryptographic keys behind a biometric gateway is disclosed. The system receives one or more private cryptographic keys from a user. The system tokenizes the one or more private cryptographic keys and associates fragment identifiers. The token values are encrypted utilizing biometric input from the user to generate cryptographic values. The cryptographic values and associated fragment identifiers are transmitted to the blockchain where they are recorded as transactions. The user's biometric input is utilized as signature for each of the records. The user utilizes the biometric input to retrieve, decode, and reassemble the private cryptographic key from the blockchain.

### RELATED APPLICATIONS

This application claims priority to and the benefit of U.S. Provisional Application No. 62/643,841, filed on Mar. 16, 2018, which is incorporated by reference herein in its entirety.

### BACKGROUND

Private security keys can be inconvenient and difficult to properly secure. Multiple private security keys are often necessary for data center management yet can be difficult to access and use simultaneously.

### BRIEF DESCRIPTION OF DRAWINGS

Illustrative embodiments are shown by way of example in the accompanying drawings and should not be considered as a limitation of the present disclosure:

FIG. 1 is a block diagram illustrating a system for securing private cryptographic keys behind a biometric gateway according to an exemplary embodiment.

FIG. 2A depicts an illustration of blocks as configured in accordance with an exemplary embodiment.

FIG. 2B depicts an illustration of transactions as configured in accordance with an exemplary embodiment.

FIG. 3 depicts a flow diagram in accordance with an exemplary embodiment.

FIG. 4 depicts a process diagram as configured in accordance with an exemplary embodiment.

FIG. 5 depicts a system diagram configured in accordance with an exemplary embodiment.

FIG. 6 depicts the processing of a private security key in accordance with an exemplary embodiment.

FIG. 7 is a flow chart illustrating a process securing private keys behind a biometric gateway in accordance with an exemplary embodiment.

FIG. 8 depicts a block diagram of an exemplary computing device in accordance with an exemplary embodiment

### DETAILED DESCRIPTION

Described in detail herein is a system for securing private cryptographic keys behind a biometric gateway in accordance with an exemplary embodiment. The system tokenizes a private cryptographic key associated with a user into one or more tokens. The system creates cryptographic values based on applying cryptographic function on the tokens and biometric input from the user. A fragment identifier is associated with each of the cryptographic values. The cryptographic values are transmitted into a network of interconnected computing devices constituting a blockchain network, where they are stored as records within the blockchain.

The systems and methods disclosed herein can be configured to comply with privacy requirements which may vary between jurisdictions. For example, before any recording, collection, capturing or processing of user biometric data, a “consent to capture” process may be implemented. In such a process, consent may be obtained, from the user, via a registration process. Part of the registration process may be to ensure compliance with the appropriate privacy laws for the location where the service would be performed. The registration process may include certain notices and disclosures made to the user prior to the user recording the user's consent. No unauthorized collection or processing of biometric data of individuals occurs via exemplary systems and methods.

After registration, and before collection or processing of biometric data of the user occurs, a verification of the user as registered with the system and providing the required consents can occur. That is, the user's registration status as having consented to the collection of biometric data can be verified prior to collecting any biometric data. This verification can take place, for example, by the user entering a PIN (Personal Identification Number), password, or other code into a keypad or keyboard; by the user entering into a limited geofence location while carrying a fob, mobile device (such as a smartphone), or other RF transmitter, where the device has been configured to broadcast an authorization signal.

Once consent is verified, biometric data of the user can be captured, processed and used. Absent verification of consent, camera, sensor, or other biometric data collection remains turned off. Once consent is verified, camera, sensor or other biometric data collection may be activated or turned on. If any biometric data is inadvertently collected from the user prior to verification of consent it is immediately deleted, not having been saved to disk.

Preferably, any biometric data captured as part of verification processes is handled and stored by a single party at a single location. Where data must be transmitted to an offsite location for verification, certain disclosures prior to consent may be required, and the biometric data is encrypted. The hashing of the biometric data received is a form of asymmetrical encryption which improves both data security and privacy, as well as reducing the amount of data which needs to be communicated.

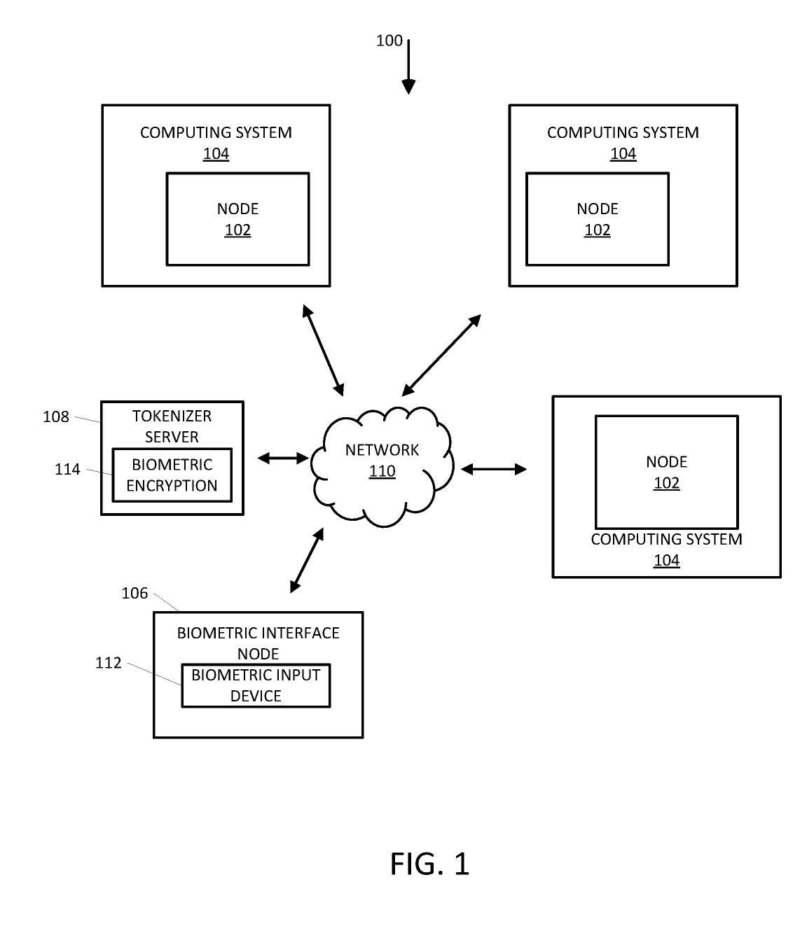

FIG. 1 is a block diagram illustrating a system for securing private cryptographic keys behind a biometric gateway according to an exemplary embodiment. In the present example embodiment, the system 100 can include one or more computing systems 104, a tokenizing server 108 and one or more biometric interface nodes 106. The computing system 104 can be in communication with other computing systems and also with the one or more biometric interface nodes 106, via a communications network 110. The computing system 104 can include one or more nodes 102. Each of the one or more nodes 102 can store a copy of a master cryptographically verifiable ledger (e.g. blockchain) record and/or a shared ledger associated with events. The one or more nodes 102 can be configured to update the blocks in the master blockchain record based on the generation of one or more cryptographic values and associated fragment identifiers. Each node 102 can locally store a copy of a sub blockchain record and/or a shared ledger.

In an example embodiment, one or more portions of the communications network 110 can be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

The computing system 104 includes one or more computers or processors configured to communicate with other computing systems, and the biometric interface nodes 106. The computing systems 104 can provide infrastructure to support the nodes 102. The storage infrastructure can be virtual or physical for the non-volatile storage of entries in the blockchain. The storage infrastructure may be abstracted from the computing system 104, wherein the node 102 interacts with the storage infrastructure without any knowledge of the underlying implementation. The nodes 102 can include a blockchain storage system that is configured to store a blockchain record or a shared ledger based on data corresponding to one or more cryptographic values received. The blockchain storage system can be inclusive to the node, and implemented through the computing system 104. The node 102 can include a master blockchain. As a non-limiting example, the node 102 can store records associated with cryptographic values corresponding to the tokenized pieces of a private cryptographic key. The computing system 104 can use the blocks of the blockchain to store records associated with the cryptographic values, including information necessary to re-assemble the private cryptographic keys using the cryptographic values and in response to receipt of a biometric input. The biometric input can be received by the computing system 104 subsequent to receiving consent from the user allowing the computing system 104 to use biometrics. The computing system 104 can be located at one or more geographically distributed locations from each other. Alternatively, one or more virtualized computing systems 104 can be implemented within one physical computing system 104.

In a non-limiting embodiment, a biometric interface node 106 can operate as the user-facing front end of the system. The biometric interface node 106 can include one or more computers or processors, as well as accompanying support software, configured to receive consent for use of biometrics associated with users and to receive biometric input as well as requests to retrieve a private cryptographic key secured with the blockchain storage system. The biometric interface node 106 can provide complementary supporting infrastructure to interface the network. The network interface can be an application programming interface (API) that defines how applications interact with other system components, including the network stack. Additionally, the biometric interface node 106 can provide an API that defines how applications interact with display components. A biometric input device 112 can be hosted on a biometric interface node 106. In some embodiments, the biometric input device 112 can be disabled (or turned off) until the user consents to the use of biometrics by the computing system 104, at which time, the biometric input device 112 can be activated (or turned on). The biometric input device 112 can communicate to other nodes 102 through APIs provided by the host biometric interface node 106. As a part of the networking API, the host biometric interface node 106 can provide a networking stack to interface and negotiate communication within the network 110. The biometric interface node 106 can request information from a node 102 through the network 110. The biometric interface node 106 can index into the blockchain utilizing the biometric input for addressing. The biometric input can be converted to a unique digital representation by a biometric input device 112, hashed, and utilized as inputs to a transaction. The biometric interface node 106 upon addressing into the blockchain can retrieve from the blockchain each of the one or more cryptographic values and each of the associated fragment identifiers from the one or more records. Upon retrieval, the biometric interface node assembles the private cryptographic key based on any associated fragment identifiers and the cryptographic values. The biometric interface node 106 can also receive a second user's biometric input, and create the cryptographic values based on both sets of biometric input. The biometric interface node 106 utilizes the biometric input device 112 for enrollment of a user in the system as well as the retrieval of the stored private cryptographic key from the blockchain. The biometric input device 112 can include an electronic computing device to support a range of biometric readers including but not limited to iris scanners, retinal scanners, fingerprint scanners, face identification scanners, and voice analyzers.

A tokenizer server 108 provides functionality for tokenizing private cryptographic keys. The tokenizer server 108 receives private cryptographic keys from the biometric interface node 106. The tokenizer server 108 tokenizes the private cryptographic key into N number of tokens. The tokenizer server 108 can utilize biometric encryption 114 functions to encrypt the tokens and information associated with the tokens, utilizing the biometric input from the biometric interface node 106. The biometric encryption 114 functions can utilize either one way functions (e.g., cryptographic hash functions) or bi-directional encryption functions which allow the recovery of the encrypted input. Upon encryption of the tokens by the biometric encryption 114 function, the tokenizer server 108 can utilize the biometric encryption 114 function to generate a one way cryptographic address key based on the biometric input to be utilized for addressing in the blockchain, as described above. In some embodiments, the tokenization server 108 can be integrated into the biometric interface node.

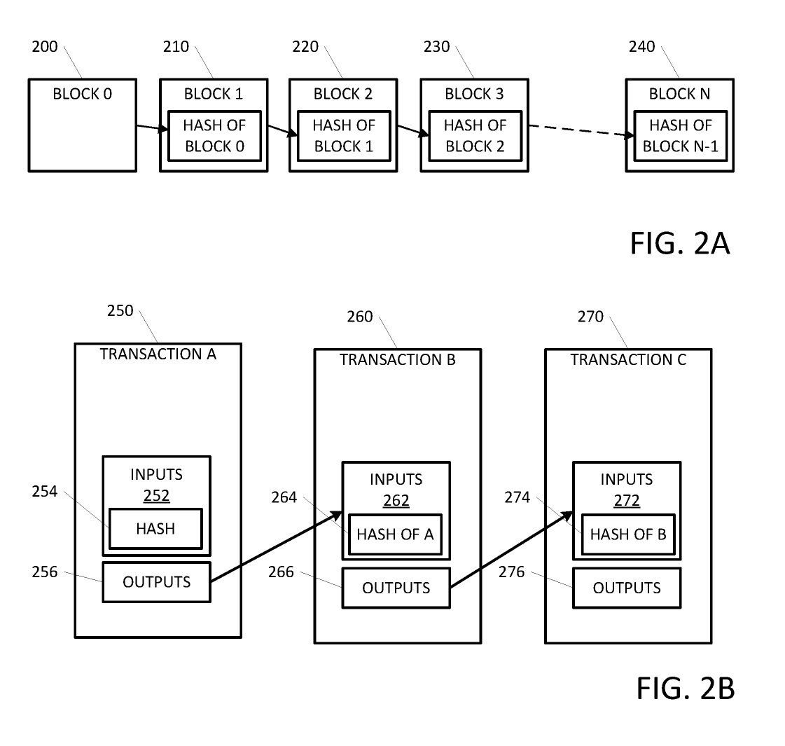

Referring to FIG. 2A, an illustration of a blockchain according to embodiments of the present disclosure is shown. A blockchain comprises a hash chain or a hash tree in which each block added in the chain contains a hash of the previous block. In FIG. 2A, block 0 200 represents a genesis block of the chain and can be generated in response to an event received associated with the addition of an encrypted token of a private cryptographic key. The block 0 200 can include information associated with the encrypted token, a hash key and a timestamp. Additionally the block 0 200 can include information a block id based on the digitized and hashed biometric input for addressing. The information associated with the encrypted token can include information utilized to reassemble the private cryptographic key, including identifiers indicating a position in the private cryptographic key that the token occupies. Block 1 210 can be generated in response to the generation of an encrypted token. The block 1 210 can contain a hash of block 0 200. The block 1 210 can include the information utilized to reassemble the private cryptographic key. Otherwise, the block 1 210 can include information that an event was not verified. Additional blocks can be generated as additional requests are received and each block that is generated can include a hash of a previous block. For example, block 2 220 can be generated in response to a subsequent request and can contain a hash of block 1 210, block 3 230 can be generated in response to a yet another subsequent request and can contain a hash of block 2 220, and so forth. Continuing down the chain, block N contains a hash of block N−1. In some embodiments, the hash may comprise the header of each block. Once a chain is formed, modifying or tampering with a block in the chain would cause detectable disparities between the blocks. For example, if block 1 is modified after being formed, block 1 would no longer match the hash of block 1 in block 2. If the hash of block 1 in block 2 is also modified in an attempt to cover up the change in block 1, block 2 would not then match with the hash of block 2 in block 3. In some embodiments, a proof standard (e.g. proof-of-work, proof-of-stake, proof-of-space, etc.) may be required by the system when a block is formed to increase the cost of generating or changing a block that could be authenticated by the consensus rules of the distributed system, making the tampering of records stored in a blockchain computationally costly and essentially impractical. In some embodiments, a blockchain may comprise a hash chain stored on multiple nodes as a distributed database and/or a shared ledger, such that modifications to any one copy of the chain would be detectable when the system attempts to achieve consensus prior to adding a new block to the chain. In some embodiments, a block may generally contain any type of data and record. In some embodiments, each block may comprise a plurality of transaction and/or activity records.

In some embodiments, the blocks generated by the nodes 102 in the computing systems 104 can contain rules and data for authorizing different types of actions and/or parties who can take action as described herein. In some embodiments, transaction and block forming rules may be part of the software algorithm on each node. When a new block is being formed, any node 102 on the system can use the prior records in the blockchain to verify whether the requested action is authorized. For example, a block may contain a digitized hash of a biometric input as a key, this design that allows the user who provided the biometric input to show possession of the private cryptographic key by the generation of the digitized hash of the biometric input. Nodes 102 may verify that the user is responsible for the one or more fragments of the private cryptographic key and is authorized to access the fragments when a block containing the transaction is being formed and/or verified. In some embodiments, rules themselves may be stored in the blockchain such that the rules are also resistant to tampering once created and hashed into a block. In some embodiments, the blockchain system may further include incentive features for nodes 102 that provide resources to form blocks for the chain. Nodes can compete to provide proof-of-work to form a new block, and the first successful node of a new block earns a reward.

Now referring to FIG. 2B, an illustration of blockchain-based transactions according to some embodiments is shown. In some embodiments, the blockchain illustrated in FIG. 2A comprises a hash chain protected by private/public key encryption. Transaction A 250 represents an event in a block of a blockchain showing a computing system creating a new block with records associated with encrypted tokens, based on a received event (e.g. a new encrypted token is received). Transaction A 250 contains inputs 252 for the previous transaction and a hash 254 of a previous block. When the computing system 104 transmits an alert indicating an additional transaction involving subcomponents described as inputs to transaction A 250, a block containing transaction B 260 is formed. The inputs 262 can include a transactional signature of the previous transaction (outputs 256) as well as details of the transaction, and a hash 254 of the previous block. The record of transaction B 260 comprises inputs 262 in the form of the output 256 of transaction A, and a hash 264 of the previous block. The output 256 can comprise a cryptographic transactional signature. Outputs including cryptographic transactional signatures can include hashes based on the contents of the transaction to identify the current transaction in subsequent transactions. Likewise, when the computing system 104 receives another encrypted token described as inputs to transaction B 260, a block containing transaction C 270 is formed. The inputs 272 for transaction C 270 are the outputs 266 from transaction B. A hash of B 274 as well as the outputs 266 of transaction B 260 is provided with the inputs 272. A transactional signature of transaction C 270, unique to this transaction but similar to the output 256 in creation, is provided as output 276, and subsequently as input into the next block.

In some embodiments, when each event is created, the system may check previous events and the outputs and hashes to determine whether the transaction is valid. In some embodiments, transactions are broadcasted in the peer-to-peer network and each node on the system may verify that the transaction is valid prior to adding the block containing the current transaction to their copy of the blockchain. In some embodiments, nodes in the system may look for the longest chain in the system to determine the most up-to-date event to prevent the current owner from double spending the asset. The transactions in FIG. 2B are shown as an example only. In some embodiments, a blockchain record and/or the software algorithm may comprise any type of rules that regulate who and how the chain may be extended. In some embodiments, the rules in a blockchain may comprise clauses of a smart contract that is enforced by the peer-to-peer network.

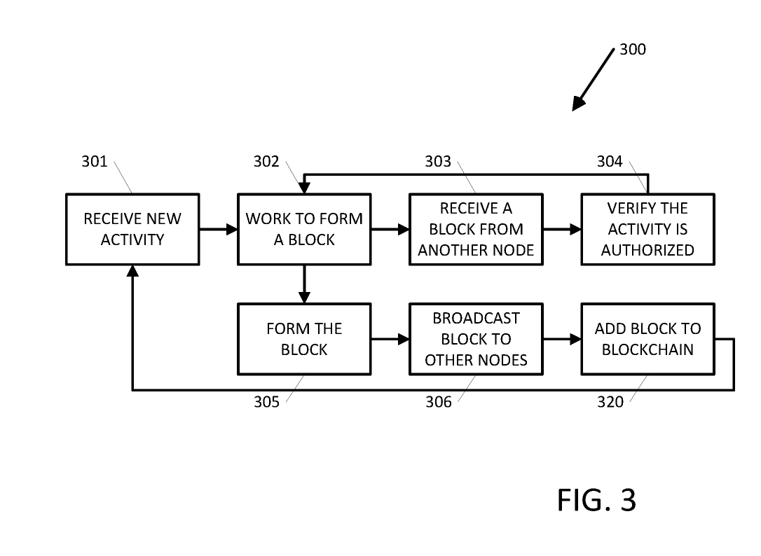

Now referring to FIG. 3, a flow diagram according to embodiments of the present disclosure is shown. In some embodiments, the steps shown in FIG. 3 may be performed by a computer system 104 as described in FIG. 1, including multiple computing systems 104, and multiple nodes 102, and the like. In some embodiments, the steps in FIG. 3 may be performed by one or more of the nodes 102 in a system using blockchain for record keeping.

In step 301, a node receives a new activity in response to receiving an event associated with receipt of biometric inputs. The new activity may comprise enrollment of a private cryptographic key to the record being kept in the form of a blockchain with biometrically signed transaction records. In some embodiments, the new activity may be broadcasted to a plurality of nodes on the network prior to step 301. For example, the nodes of different computing systems may be notified. In step 302, the node works to form a block to update the blockchain. In some embodiments, a block may comprise a plurality of fragments of a private cryptographic key and a hash of one or more previous blocks in the blockchain. In some embodiments, the system may comprise consensus rules for storage of fragments of a private cryptographic key as individual transactions and/or blocks and the node may work to form a block that conforms to the consensus rules of the system. In some embodiments, the consensus rules may be specified in the software program running on the node. For example, a node may be required to provide a proof standard (e.g. proof of work, proof of stake, etc.) which requires the node to solve a difficult mathematical problem or form a nonce in order to form a block. In some embodiments, the node may be configured to verify that the activity is authorized prior to working to form the block. In some embodiments, whether the activity is authorized may be determined based on records in the earlier blocks of the blockchain itself.

After step 302, if the node successfully forms a block in step 305 prior to receiving a block from another node, the node broadcasts the block to other nodes over the network in step 306. In step 320, the node then adds the block to its copy of the blockchain. In the event that the node receives a block formed by another node in step 303 prior to being able to form the block, the node works to verify that the activity (e.g., authentication of transfer) recorded in the received block is authorized in step 304. In some embodiments, the node may further check the new block against system consensus rules for blocks and activities to verify whether the block is properly formed. If the new block is not authorized, the node may reject the block update and return to step 302 to continue to work to form the block. If the new block is verified by the node, the node may express its approval by adding the received block to its copy of the blockchain in step 320. After a block is added, the node then returns to step 301 to form the next block using the newly extended blockchain for the hash in the new block.

In some embodiments, in the event one or more blocks having the same block number is received after step 320, the node may verify the later arriving blocks and temporarily store these blocks if they pass verification. When a subsequent block is received from another node, the node may then use the subsequent block to determine which of the plurality of received blocks is the correct/consensus block for the blockchain system on the distributed database and update its copy of the blockchain accordingly. In some embodiments, if a node goes offline for a time period, the node may retrieve the longest chain in the distributed system, verify each new block added since it has been offline, and update its local copy of the blockchain prior to proceeding to step 301.

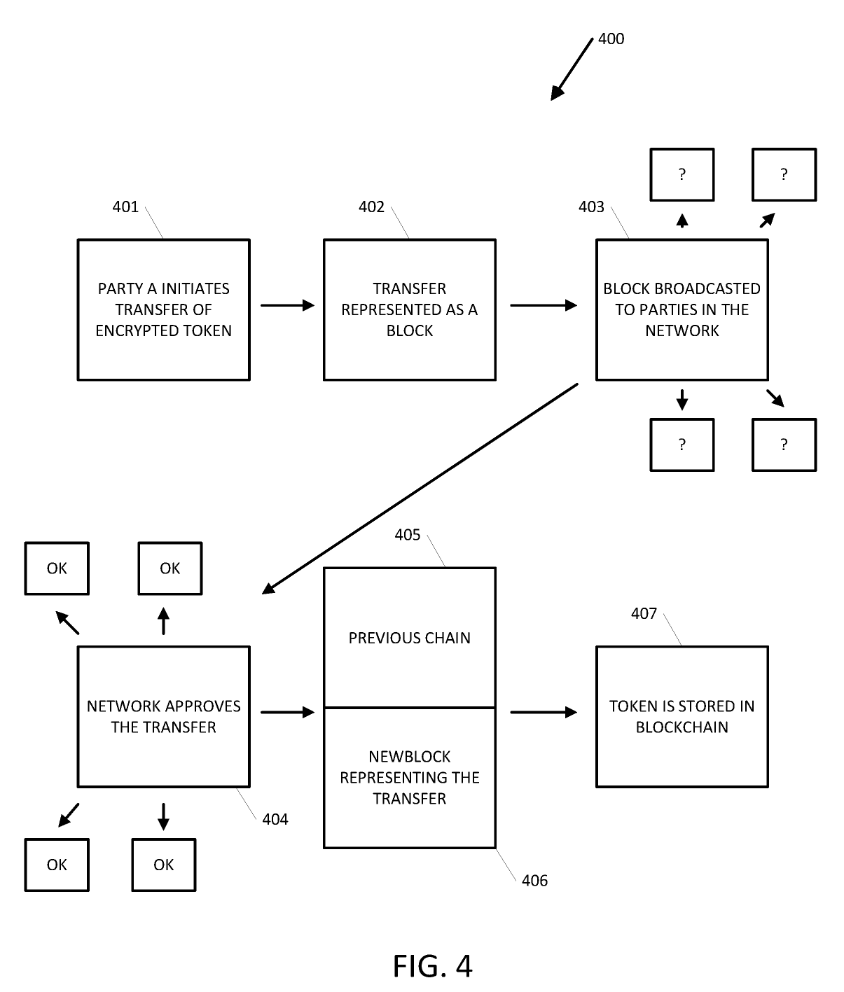

Now referring to FIG. 4, a process diagram, a blockchain update according to some implementations is shown. In step 401, party A (computing system 104) receives an event associated with encrypted tokens. In some embodiments, Party A may be authenticated by signing the transaction with an output in the previous transaction. In step 402, the authentication initiated in step 401 is represented as a block. In some embodiments, the transaction may be compared with events in the longest chain in the distributed system to verify party A's authentication. In some embodiments, a plurality of nodes in the network may compete to form the block containing the authentication record. In some embodiments, nodes may be required to satisfy proof-of-work by solving a difficult mathematical problem to form the block. In some embodiments, other methods of proof such as proof-of-stake, proof-of-space, etc. may be used in the system. In step 403, the block is broadcasted to parties in the network. In step 404, nodes in the network authenticate party A by examining the block that contains party A's authentication. In some embodiments, the nodes may check the solution provided as proof-of-work to approve the block. In some embodiments, the nodes may check the transaction against the event in the longest blockchain in the system to verify that the transaction is valid (e.g. party A is in possession of the encrypted token). In some embodiments, a block may be approved with consensus of the nodes in the network. After a block is approved, the new block 406 representing the authentication is added to the existing chain 405 comprising blocks that chronologically precede the new block 406. The new block 406 may contain the transaction(s) and a hash of one or more blocks in the existing chain 405. In some embodiments, each node may then update their copy of the blockchain with the new block and continue to work on extending the chain with additional transactions. In step 407, when the chain is updated with the new block, the encrypted token is stored throughout the nodes of the blockchain.

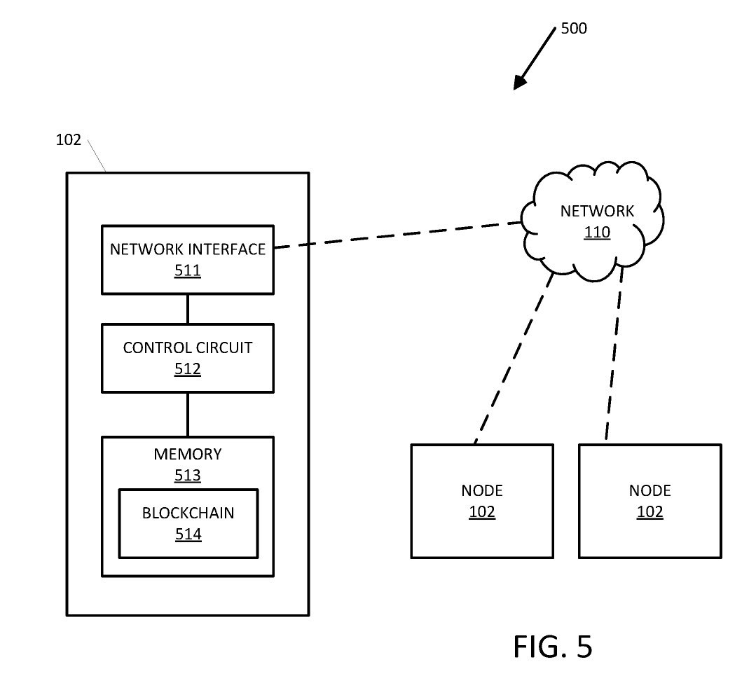

Now referring to FIG. 5, a system according to some embodiments is shown. A system for securing private keys behind a biometric gateway comprises a plurality of nodes 102 communicating over a network 110. In some embodiments, the nodes 102 may comprise a distributed blockchain server and/or a distributed timestamp server. Each node 102 in the system comprises a network interface 511, a control circuit 512, and a memory 513.

The control circuit 512 may comprise a processor, a microprocessor, and the like and may be configured to execute computer-readable instructions stored on a computer-readable storage memory 513. The computer-readable storage memory may comprise volatile and/or non-volatile memory and have stored upon it a set of computer-readable instructions which, when executed by the control circuit 512, causes the node 102 update the blockchain 514 stored in the memory 513 based on communications with other nodes 102 over the network 110. In some embodiments, the control circuit 512 may further be configured to extend the blockchain 514 by processing updates to form new blocks for the blockchain 514. Generally, each node may store a version of the blockchain 514, and together, may form a distributed database. In some embodiments, each node 102 may be configured to perform one or more steps described with reference to FIGS. 2-4 herein.

The network interface 511 may comprise one or more network devices configured to allow the control circuit to receive and transmit information via the network 110. In some embodiments, the network interface 511 may comprise one or more of a network adapter, a modem, a router, a data port, a transceiver, and the like. The network 110 may comprise a communication network configured to allow one or more nodes 102 to exchange data. In some embodiments, the network 110 may comprise one or more of the Internet, a local area network, a private network, a virtual private network, a home network, a wired network, a wireless network, and the like. In some embodiments, the system does not include a central server and/or a trusted third party system. Each node in the system may enter and leave the network at any time.

With the system and processes shown, once a block is formed, the block cannot be changed without redoing the work to satisfy census rules thereby securing the block from tampering. A malicious attacker would need to provide proof standard for each block subsequent to the one he/she seeks to modify, race all other nodes and overtake the majority of the system to affect change to an earlier record in the blockchain.

In some embodiments, blockchain may be used to support a payment system based on cryptographic proof instead of trust, allowing any two willing parties to transact directly with each other without the need for a trusted third party. A blockchain system uses a peer-to-peer distributed timestamp server to generate computational proof of the chronological order of transactions. Generally, a blockchain system is secure as long as honest nodes collectively control more processing power than any cooperating group of attacker nodes. With a blockchain, the events are computationally impractical to reverse. As such, sellers are protected from fraud and buyers are protected by the routine escrow mechanism.

In some embodiments, in the peer-to-peer network, the longest chain proves the sequence of events witnessed, proves that it came from the largest pool of processing power, and that the integrity of the document has been maintained. In some embodiments, the network for supporting blockchain-based record keeping requires minimal structure. In some embodiments, messages for updating the record are broadcast on a best-effort basis. Nodes can leave and rejoin the network at will and may be configured to accept the longest proof-of-work chain as proof of what happened while they were away.

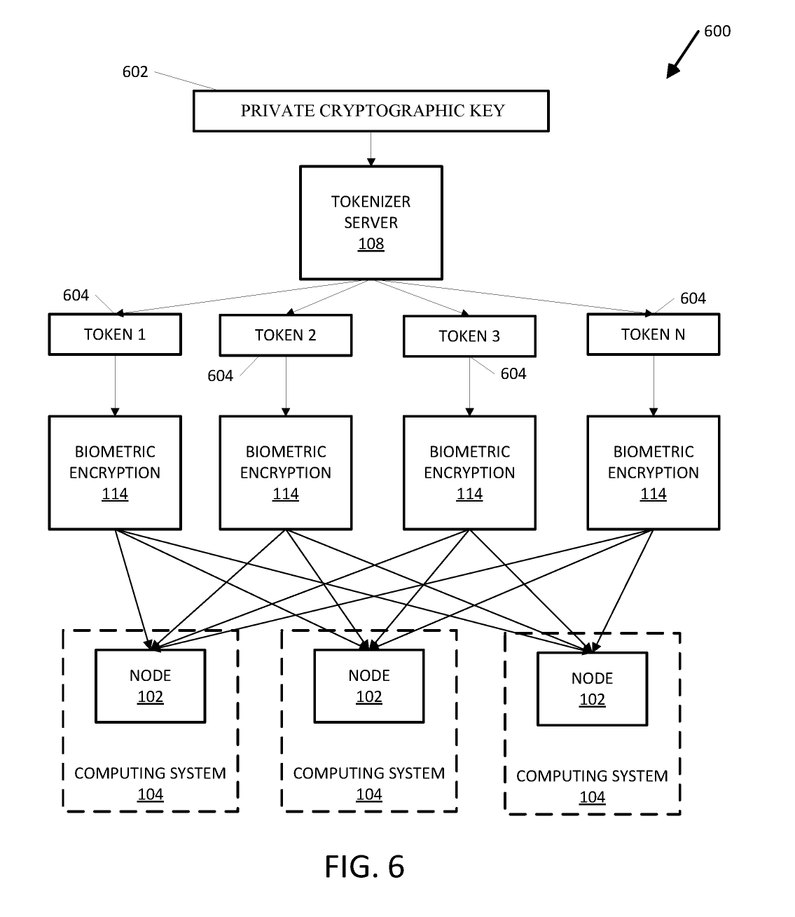

FIG. 6 depicts the processing 600 of a private cryptographic key in accordance with an exemplary embodiment. The private cryptographic key 602 is received by the system. The private cryptographic key 602 can be a cryptographic key utilized by a user to access a secured system. The private cryptographic key 602 can be a string of characters corresponding to a verified credential to access the secured system. The private cryptographic key 602 can be processed by a tokenizer server 108. The tokenizer server 108 tokenizes the private cryptographic key by dividing the string of characters into a number N of substrings, or tokens, of the original private cryptographic key. The substrings are represented as N tokens 604. The tokens can require ordering information to properly reconstruct the original private cryptographic key 602. The tokens 604 and any resulting ordering information can be passed for processing by biometric encryption 114. The biometric encryption 114 applies biometric information obtained from a biometric input device 112 as an input for encrypting each of the tokens and any resulting ordering information resulting in a cryptographic value. Each cryptographic value can then be inserted as transaction records into the blockchain hosted within each node 102. Each cryptographic value is hosted at each node 102 within the blockchain and propagates through the blockchain network through the peer-to-peer network and the authentication mechanisms of the blockchain.

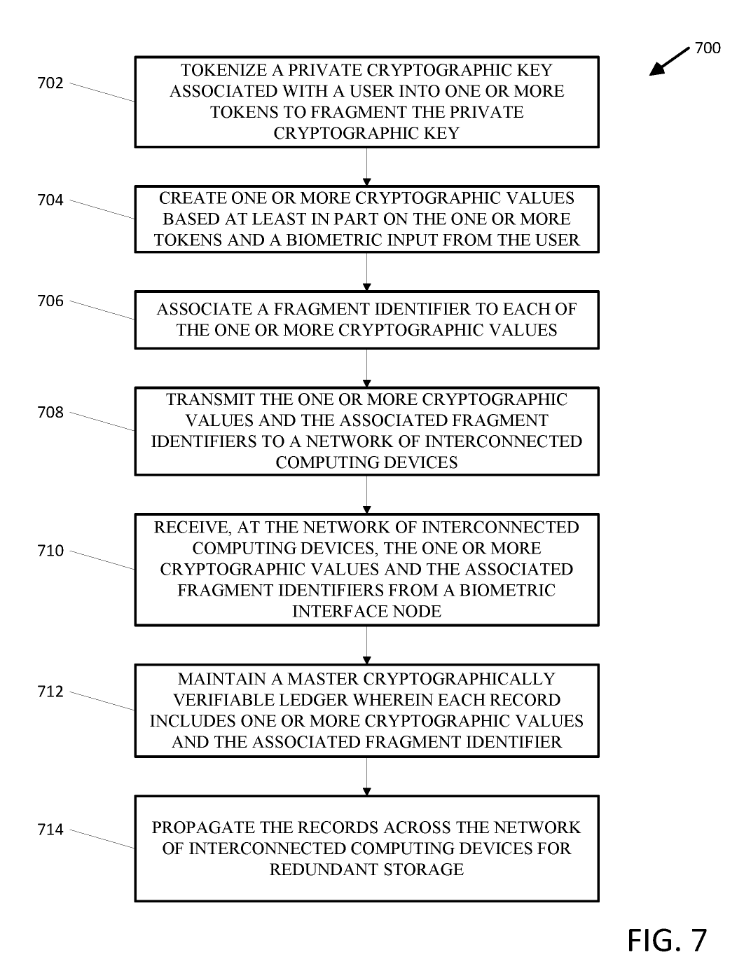

FIG. 7 is a flow chart illustrating a process securing private cryptographic keys behind a biometric gateway in accordance with an exemplary embodiment.

At step 702, the tokenizer server 108 tokenizes a private cryptography key associated with a user into one or more tokens to fragment the private cryptography key. The private cryptography key can be supplied by a user. Alternatively, more than one private cryptographic key can be supplied by the user as well as information associating them to their respective secured systems.

At step 704, the tokenizer server 108 creates one or more cryptographic values based at least in part on the one or more token and a biometric input from the user. The tokenizer server 108 utilizes the biometric input as an input into an encryption/decryption routine to obfuscate the tokenized private cryptographic key(s).

At step 706, the tokenizer server 108 associates a fragment identifier to each of the one or more cryptographic values. The tokenizer server 108 identifies the order in which the tokens appeared within the private cryptographic key(s). Alternatively, the tokenizer server 108 can include the fragment identifier with each of the tokens of the private cryptographic key, prior to the creation of the one or more cryptographic value. Utilizing both the fragment identifier with the each token provides more obfuscation of the ordering of the tokens, and thereby the private cryptographic key.

At step 708, the tokenizer server 108 transmits the one or more cryptographic values and the associated fragment identifiers to a network of interconnected computing devices.

At step 710, the network of interconnected computing devices receives the one or more cryptographic values and the associated fragment identifiers from a biometric interface node. The network of interconnected computing devices can include one or more of computing systems 104 each hosting one or more nodes 102 of the blockchain system.

At step 712, the network of interconnected computing devices maintains a master cryptographically verifiable ledger wherein each record includes one or more cryptographic values and the associated fragment identifier. Each of the nodes 102 validates the received record based on signatures corresponding to the biometric input.

At step 714 the network of interconnected computing devices propagates the records across the network of interconnected computing devices for redundant storage. Upon validation, the record is transmitted utilizing peer-to-peer interfaces to duplicate the record within each node instance of the blockchain.

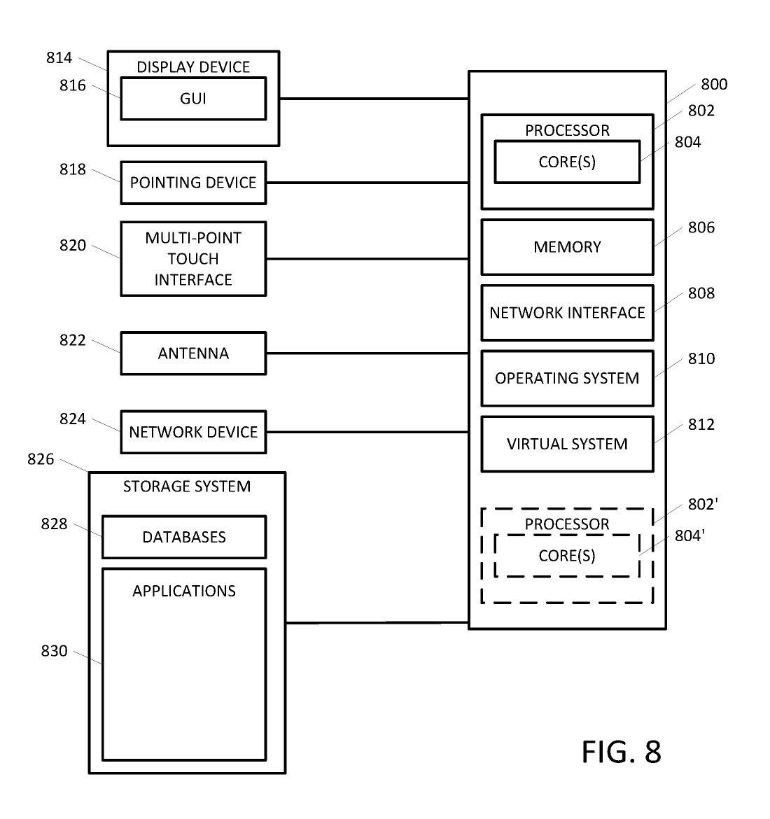

FIG. 8 depicts a block diagram of an exemplary computing device in accordance with an exemplary embodiment. Embodiments of the computing device 800 can implement embodiments of the system for securing private keys behind a biometric authentication gateway. For example, the computing device can be embodied as a portion of the computing system, and biometric interface nodes. The computing device 800 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives, one or more solid state disks), and the like. For example, memory 806 included in the computing device 800 may store computer-readable and computer-executable instructions or software (e.g., applications 830 such as the biometric interface node 106) for implementing exemplary operations of the computing device 800. The computing device 800 also includes configurable and/or programmable processor 802 and associated core(s) 804, and optionally, one or more additional configurable and/or programmable processor(s) 802′ and associated core(s) 804′ (for example, in the case of computer systems having multiple processors/cores), for executing computer-readable and computer-executable instructions or software stored in the memory 806 and other programs for implementing exemplary embodiments of the present disclosure. Processor 802 and processor(s) 802′ may each be a single core processor or multiple core (804 and 804′) processor. Either or both of processor 802 and processor(s) 802′ may be configured to execute one or more of the instructions described in connection with computing device 800.

Virtualization may be employed in the computing device 800 so that infrastructure and resources in the computing device 800 may be shared dynamically. A virtual machine 812 may be provided to handle a process running on multiple processors so that the process appears to be using only one computing resource rather than multiple computing resources. Multiple virtual machines may also be used with one processor.

Memory 806 may include a computer system memory or random access memory, such as DRAM, SRAM, EDO RAM, and the like. Memory 806 may include other types of memory as well, or combinations thereof. The computing device 800 can receive data from input/output devices. A user may interact with the computing device 800 through a visual display device 814, such as a computer monitor, which may display one or more graphical user interfaces 816, multi touch interface 820 and a pointing device 818.

The computing device 800 may also include one or more storage devices 826, such as a hard-drive, CD-ROM, or other computer-readable media, for storing data and computer-readable instructions and/or software that implement exemplary embodiments of the present disclosure. For example, exemplary storage device 826 can include one or more databases 828 for storing information associated with one or more subcomponents and events associated with the one or more subcomponents. The databases 828 may be updated manually or automatically at any suitable time to add, delete, and/or update one or more data items in the databases.

The computing device 800 can include a network interface 808 configured to interface via one or more network devices 824 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. In exemplary embodiments, the computing system can include one or more antennas 822 to facilitate wireless communication (e.g., via the network interface) between the computing device 800 and a network and/or between the computing device 800 and other computing devices. The network interface 808 may include a built-in network adapter, network interface card, PCMCIA network card, card bus network adapter, wireless network adapter, USB network adapter, modem or any other device suitable for interfacing the computing device 800 to any type of network capable of communication and performing the operations described herein.

The computing device 800 may run any operating system 810, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the computing device 800 and performing the operations described herein. In exemplary embodiments, the operating system 810 may be run in native mode or emulated mode. In an exemplary embodiment, the operating system 810 may be run on one or more cloud machine instances.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes multiple system elements, device components or method steps, those elements, components, or steps can be replaced with a single element, component, or step. Likewise, a single element, component, or step can be replaced with multiple elements, components, or steps that serve the same purpose. Moreover, while exemplary embodiments have been shown and described with references to particular embodiments thereof, those of ordinary skill in the art will understand that various substitutions and alterations in form and detail can be made therein without departing from the scope of the present disclosure. Further, still, other aspects, functions, and advantages are also within the scope of the present disclosure.

Exemplary flowcharts are provided herein for illustrative purposes and are non-limiting examples of methods. One of ordinary skill in the art will recognize that exemplary methods can include more or fewer steps than those illustrated in the exemplary flowcharts and that the steps in the exemplary flowcharts can be performed in a different order than the order shown in the illustrative flowcharts.

We claim:

1. A system for securing private cryptographic keys behind a biometric authentication gateway comprising:
a biometric interface node, wherein the biometric interface node is configured to:
tokenize a private cryptographic key associated with a user into one or more tokens to fragment the private cryptographic key;
create one or more cryptographic values based at least in part on the one or more tokens and a biometric input from the user;
associate a fragment identifier to each of the one or more cryptographic values;
transmit the one or more cryptographic values and the associated fragment identifiers to a network of interconnected computing devices;
a network of interconnected computing devices communicatively coupled to the biometric interface node, wherein the interconnected computing devices are configured to:
receive one or more cryptographic values and the associated fragment identifiers;
maintain a master cryptographically verifiable ledger represented by a sequence of blocks, each block containing one or more records and each subsequent block containing a hash value associated with the previous block, wherein each of the one or more records includes one of the one or more cryptographic values and the associated fragment identifier; and
propagate the one or more records across the network of interconnected computing devices, wherein each of the computing devices maintains a copy of the one or more records.

2. The system of claim 1, wherein the biometric interface node is further configured to:
receive a biometric input from a user subsequent to receipt of consent from the user;
index into the master cryptographically verifiable ledger utilizing the biometric input,
and retrieve, based on the indexing, each of the one or more cryptographic values and each of the associated fragment identifiers from the one or more records.

3. The system of claim 2 wherein each of the associated fragment identifiers indicates an ordering of each of the one or more cryptographic values.

4. The system of claim 3, wherein biometric interface node assembles the private cryptographic key based on the associated fragment identifiers and the one or more cryptographic values.

5. The system of claim 1, wherein the biometric interface node is further configured to:
receive a second biometric input from a second user; and
create one or more cryptographic values based at least in part on the one or more tokens, the biometric input and the second biometric input.

6. The system of claim 1, wherein the biometric interface node comprises an electronic computing device and at least one selected from the group of an iris scanner, retinal scanner, fingerprint scanner, face identification scanner, and voice analyzer.

7. The system of claim 1, wherein the private cryptographic key is tokenized on a tokenization server.

8. A method for securing private keys behind a biometric authentication gateway comprising:
tokenizing a private cryptographic key associated with a user into one or more tokens to fragment the private cryptographic key;
creating one or more cryptographic values based at least in part on the one or more tokens and a biometric input from the user;
associating a fragment identifier to each of the one or more cryptographic values;
transmitting the one or more cryptographic values and the associated fragment identifiers to a network of interconnected computing devices;
receiving, at the network of interconnected computing devices, the one or more cryptographic values and the associated fragment identifiers from a biometric interface node;
maintaining a master cryptographically verifiable ledger represented by a sequence of blocks, each block containing one or more records and each subsequent block containing a hash value associated with the previous block, wherein each of the one or more records includes one of the one or more cryptographic values and the associated fragment identifier; and
propagating the one or more records across the network of interconnected computing devices, wherein each of the computing devices maintains a copy of the one or more records.

9. The method of claim 8, further comprising:
receiving a biometric input from a user subsequent to receipt of consent from the user;
indexing into the master cryptographically verifiable ledger utilizing the biometric input,
and retrieving, based on the indexing, each of the one or more cryptographic values and each of the associated fragment identifiers from the one or more records.

10. The method of claim 9, wherein each of the associated fragment identifiers indicates an ordering of each of the one or more cryptographic values.

11. The method of claim 10, wherein the biometric interface node assembles the private cryptographic key based on the associated fragment identifiers and the one or more cryptographic values.

12. The method of claim 8, further comprising:
receiving a second biometric input from a second user; and
creating one or more cryptographic values based at least in part on the one or more tokens, the biometric input and the second biometric input.

13. The method of claim 8, wherein the biometric interface node comprises an electronic computing device and at least one selected from the group of an iris scanner, retinal scanner, fingerprint scanner, face identification scanner, and voice analyzer.

14. The method of claim 8, wherein the private cryptographic key is tokenized on a tokenization server.

15. A non-transitory computer-readable medium for securing private keys behind a biometric authentication gateway, having stored thereon, instructions that when executed in a computing system, cause the computing system to perform operations comprising:
tokenizing a private cryptographic key associated with a user into one or more tokens to fragment the private cryptographic key;
creating one or more cryptographic values based at least in part on the one or more tokens and a biometric input from the user;
associating a fragment identifier to each of the one or more cryptographic values;
transmitting the one or more cryptographic values and the associated fragment identifiers to a network of interconnected computing devices;
receiving, at the network of interconnected computing devices, the one or more cryptographic values and the associated fragment identifiers from a biometric interface node;
maintaining a master cryptographically verifiable ledger represented by a sequence of blocks, each block containing one or more records and each subsequent block containing a hash value associated with the previous block, wherein each of the one or more records includes one of the one or more cryptographic values and the associated fragment identifier; and
propagating the one or more records across the network of interconnected computing devices, wherein each of the computing devices maintains a copy of the one or more records.

16. The computer-readable medium of claim 15, wherein the operations further comprise:
receiving a biometric input from a user subsequent receipt of consent from the user;
indexing into the master cryptographically verifiable ledger utilizing the biometric input,
and retrieving, based on the indexing, each of the one or more cryptographic values and each of the associated fragment identifiers from the one or more records.

17. The computer-readable medium of claim 16 wherein each of the associated fragment identifiers indicates an ordering of each of the one or more cryptographic values.

18. The computer-readable medium of claim 17, wherein biometric interface node assembles the private cryptographic key based on the associated fragment identifiers and the one or more cryptographic values.

19. The computer-readable medium of claim 15, wherein the operations further comprise:
receiving a second biometric input from a second user; and
creating one or more cryptographic values based at least in part on the one or more tokens, the biometric input and the second biometric input.

20. The computer-readable medium of claim 15, wherein the biometric interface node comprises an electronic computing device and at least one selected from the group of an iris scanner, retinal scanner, fingerprint scanner, face identification scanner, and voice analyzer.
